(19) United States
(12) Patent Application Publication
(10) Pub. No.: US 2002/0087351 A1
(43) Pub. Date: Jul. 4, 2002

(54) Method of managing use of an appliance through a communication network

(75) Inventor: Seong Jin Jo, Changwon-si (KR)

Correspondence Address: FLESHNER & KIM, LLP, P.O. Box 221200, Chantilly, VA, 20153-1200, US

(73) Assignee: LG Electronics Inc.

(21) Appl. No.: 10/029,240

(22) Filed: Dec. 28, 2001

(30) Foreign Application Priority Data
Dec. 28, 2000 (KR) 00-84612

(51) Int. Cl. G06F 17/60

(52) U.S. Cl. 705/1; 705/400

(57) ABSTRACT

The present invention relates to a method of managing the use of rented electric home appliances such as a washing machine, a dish washer, and so on, through a communication network and charging for the use thereof. The method includes receiving information on use of the appliance through a communication network, calculating a charge for use of the appliance based on the received information, and transmitting the calculated charge to a user's terminal through the communication network. The method obviates the need to buy home appliances and avoids the inconvenience of appliance installation, maintenance, replacement and moving. Additionally, a subscriber can easily upgrade to a brand-new appliance as provided by the rental company. As a result, the rental service provider can satisfy various consumer's or subscriber's needs promptly resulting in increased profits.

### BACKGROUND OF THE INVENTION

1. Field of the Invention

The present invention relates to a method of managing use of electric appliances.

2. Background of the Related Art

Electric appliances, and more particularly, home electric appliances such as washers, dryers, refrigerators, dishwashers, microwave ovens, conventional ovens, stoves, air conditioners, forced air furnaces and other types of living-space heaters, etc. enjoy widespread use. Though the present invention is applicable to all types of electronic appliances, either in a home or other type of user environment such as an office, factory, warehouse, business, etc., the description of the invention will focus on a washing machine as an illustrative example.

The washing machine, one of many electric home appliances, is very popular due to its efficient washing ability and its ease of use. The typical washing machine has various washing course programs in its memory, each of which automatically sets a washing time, rinsing time, agitation or spinning time, etc. when selected by a user. The programmed settings are appropriate to the amount of clothes and cloth material being washed in order to prevent damage to the clothes as well as washing more effectively.

The washing course programs usually include settings for a spinning wash, a high-concentrated wash, a first laundering, a pulsating wash, a clothes-soaking wash, a wool-fabric wash, etc. Thus, a user can wash clothes automatically simply by selecting the washing course program he or she wants.

A modern single or multi-family house, apartment, dormitory of a company or a school will typically have a washing machine as well as other appliances as built-in fixtures. Moving such built-in appliances requires substantial work which is preferably avoided. In addition, when a large number of people are living in a living space such as a dormitory, a home-combined office, or a studio apartment, etc. a new washing machine of larger load capacity is necessary, requiring expensive replacement and disposal of the previous appliance.

Another problem of the related art is that washing clothes in a public washing facility is inconvenient while a person is on a business trip or otherwise traveling due to the need to provide the required change to operate the machine.

### SUMMARY OF THE INVENTION

An object of the invention is to solve at least the above problems and/or disadvantages and to provide at least the advantages described hereinafter.

It is an object of the present invention to provide a method of managing use history of rental electric home appliances through a communication network which enables a person to wash clothes with a rental washing machine installed at an individual house or other location.

It is another object of the present invention to provide a method of managing use of rental electric home appliances through a communication network which can charge each subscriber for time or amount of use of the electric home appliances rented to the subscriber.

It is another object of the present invention to provide a method of managing use of rental electric home appliances through a communication network, more particularly, to a method of receiving usage details of rental electric home appliances such as a washing machine, a dish washer, and so on through a communication network and calculating a charge based on the usage details.

An embodiment of the method of managing use of a rental electric home appliance through a communication network according to the present invention includes receiving information on use details of the rental electric home appliance through the communication network, calculating a charge for use of the rental electric home appliance based on the received information on use details, and transmitting the calculated charge to a user's computer terminal through the communication network.

Another method of managing use of a rental electric home appliance through a communication network according to an embodiment of the present invention includes authenticating a subscriber number received through the communication network, transmitting a start signal for the rental electric home appliance identified by the subscriber number through the communication network to a corresponding subscriber's terminal if the subscriber number is authenticated successfully, receiving use information for the rental electric home appliance through the communication network, calculating a charge for use of the rental electric home appliance based on the received use information, and transmitting the calculated charge to the user's terminal through the communication network.

Another method of managing use of a rental washing machine through a communication network according to an embodiment of the present invention includes receiving information through the communication network on washing settings of an optimal washing program based on clothes inserted in the rental washing machine, calculating charge for use of the rental electric home appliance based on the received information on washing program settings, transmitting the calculated charge to a user's terminal through the communication network, and transmitting a start signal to the rental washing machine through the communication network if a washing request is received.

Another method of managing use of a rental washing machine through a communication network according to an embodiment of the present invention includes authenticating a subscriber number received through the communication network, receiving information through the communication network on washing conditions of an optimal washing program setting based on clothes inserted in the rental washing machine, calculating a charge for use of the rental electric home appliance if the subscriber number is authenticated successfully, transmitting the calculated charge to the user's terminal through the communication network, and transmitting a start signal to the rental washing machine through the communication network if a washing request is received.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings, in which like reference numerals refer to like elements, and wherein:

FIG. 1 shows a system into which an embodiment of the present method can be embedded;

FIG. 2 is a flowchart of an embodiment of a method of managing use of rental electric home appliances through a communication network according to the present invention; and

FIG. 3 is a flowchart of another embodiment of a method of managing use of rental electric home appliances through a communication network according to the present invention.

### DETAILED DESCRIPTION OF PREFERRED EMBODIMENTS

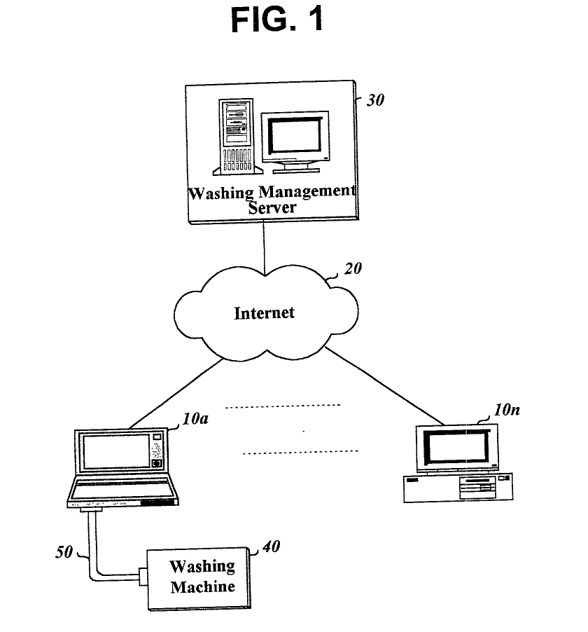

FIG. 1 shows a system in which an embodiment of the present method is included. The system relies on a communication network such as telephone lines, a coaxial cable network, a radio communication network, etc. The communication network is preferably the Internet. The system of FIG. 1 includes the Internet 20, a washing management server 30 running a washing related web site, terminals 10a to 10n capable of connecting to the washing related web site, and a washing machine 40 configured to communicate with each of the terminals 10a to 10n through an interfacing means 50.

The terminals 10a to 10n are preferably equipped with a data input means such as a keyboard, an electronic pen, a mouse, or facsimile or a voice recognition software. The terminal preferably also includes an information display means such as a video monitor, an LCD (liquid crystal display) or a printer. The terminal may also include an outputting means such as a speaker, a processing means such as a CPU (central processing unit), and embedded software such as a web browser.

The terminals 10a to 10n are depicted as a notebook or personal computer in FIG. 1, however the terminals can also be mobile communication stations capable of connecting to the washing management server 30 through the Internet 20 with an embedded WAP protocol or other wireless communication software. If a mobile communication station is used, the mobile communication station has an advantage over a notebook or a personal computer of remote control of a washing machine, however, a mobile communication network is preferably additionally used.

The washing management server 30 preferably stores registered information of each subscriber or consumer where the registered information includes a subscriber number. The washing management server 30 may also store information such as a unique number for a washing machine for identification purposes, type of rental washing machine (drum, agitator, pulsator, twin tub, drier-combined, etc.), the load capacity of a washing machine (5 kg, 6 kg, . . . , l3 kg, etc.), and the motor type of a washing machine (BLDC, induced, SPJYI, etc.).

In operation, the washing management server 30 receives washing condition information selected and entered by a subscriber through a front panel of the washing machine 40. The washing condition information may include agitation settings, for example, gentlest, medium-gentle, medium, medium-heavy, heavy, heaviest, etc., water level, a type of washing program (for example, agitation or spinning wash, high-concentrated wash, a first laundering, pulsating wash, clothes-soaking wash, etc.), washing time (for example, 10 minutes-2 hours), the number of washing repetitions, the number of agitation or spinning cycles, agitation or spinning time, the number of rinsing repetitions, etc. This information is delivered to the washing management server 30 through one of the terminals 10a to 10n and preferably via the Internet 20. In general, this information is usage information.

The washing management server 30 calculates the charge for washing based on the received washing condition information and the registered information. When clothes are washed at the washing machine 40, the washing management server 30 adds the calculated charge to the total sum which will be sent to the user's terminal through the Internet 20.

Alternatively, instead of the subscriber entering a selection of washing condition information, the washing machine 40 can automatically select the washing conditions appropriate for the amount of clothes to be washed. The washing machine 40 may automatically select the washing conditions after measuring the load of clothes placed in the washing machine 40 if a subscriber has chosen the automatic washing operation. The chosen washing conditions can then be transmitted to the washing management server 30 through one of the terminals 10a to 10n and the Internet 20. In general, the washing machine 40 can measure the amount of clothes to be washed by shaking the washing tub by methods known in the art. Therefore, the washing machine 40 can measure the load to be washed and automatically select the optimal washing course program, washing time, the number of washing repetitions, the number of agitation or spin cycles, time of each agitation or spin cycle, the number of rinsing repetitions, etc. based on the measured load.

The washing machine 40 may be installed at a subscriber's or consumer's house when it is rented upon a subscriber's request. Alternatively, the machine 40 may be installed in a laundry business or a laundry facility of an apartment complex, or hotel or motel, etc. by a washing business running the washing management server 30. If the washing machine 40 is rented to a consumer for private use, the washing business would probably install the washing machine 40 in the consumer's house and provide a subscriber number to the consumer. If the washing machine 40 is installed in a laundry etc., the washing management server 30 may manage a plurality of subscribers for the washing machine 40.

In FIG. 1, where it is presumed that the washing machine 40 has been installed in a private house, the washing machine 40 is connected to a single terminal, however one or more terminals may be connected to a plurality of washing machines installed in a laundry facility. If the amount of data to be exchanged with the washing management server 30 is relatively small, a single terminal may be used for the plurality of washing machines. The interfacing means 50 including a connecting cable may be an RS-232C device, a modem which is generally used for serial communication between a computer and an external apparatus, or other means known in the art for interfacing a computer with an external apparatus.

I/O (input/output) ports for connecting the interfacing means 50 are equipped at the washing machine 40 and the terminal 10a, respectively. The washing machine 40 and the terminal 10a can transfer data between each other through the interfacing means 50 connected to each I/O port.

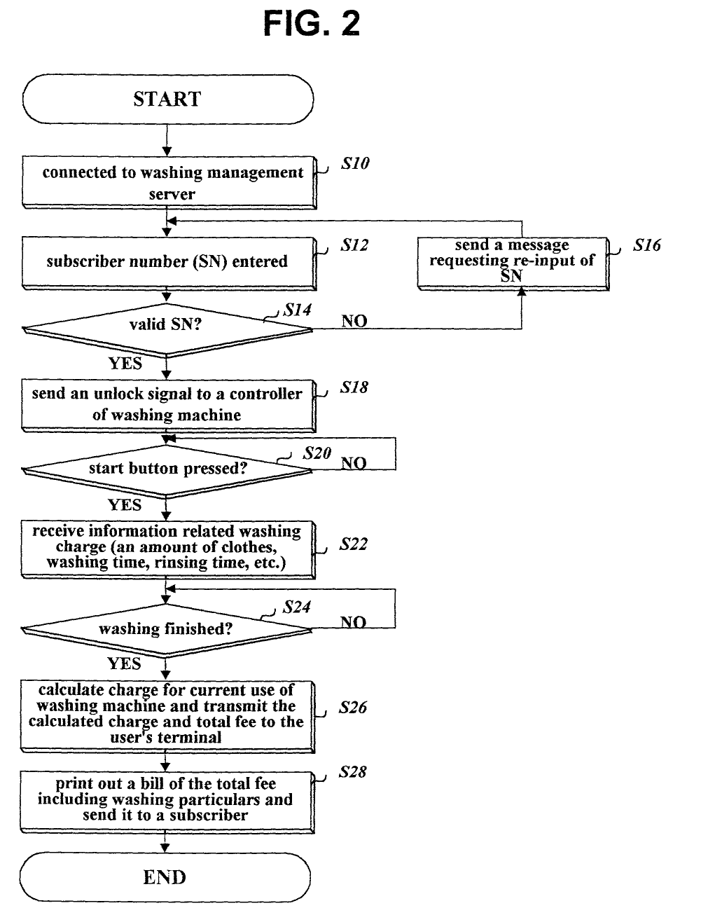

FIG. 2 is a flowchart of an embodiment of a method of managing use of rental electric home appliances through a communication network. FIG. 2 illustrates the steps that a rental washing machine may use and how each washing service is charged when the rental washing machine has been activated by a user making a rental request of the washing machine to the washing management server 30. Whether a washing machine has been installed in a laundry facility or other location does not make a difference in the procedures of FIG. 2.

To begin use of the appliance, a subscriber enters his or her subscriber number, through one of the terminals 10a to 10n. Subscriber number entry is done after the terminal used for entry is connected to a web site being run by the washing management server 30 through the Internet 20 (S10, S12). The entered subscriber number is transmitted to the washing management server 30 through Internet 20. The washing management server 30 then authenticates the received subscriber number based on the registered subscriber information (S14).

If the received subscriber number can not be authenticated at the authentication step (“No” at the step S14), the washing management server 30 sends a message requesting re-input of a subscriber number to the user's terminal through the Internet 20 (S16). If the received subscriber number is valid (“Yes” at the step S14), the washing management server 30 sends an “unlock” signal. The “unlock” signal is received by a controller of the washing machine through the Internet 20 and the user's terminal (S18). The “unlock” signal sent to the controller deactivates the security system of the washing machine and configures the washing machine for use.

After the washing machine 30 is ready for use, the subscriber selects usage information such as the amount of clothes, a washing course program, a washing time, the number of washing repetitions, the number of agitation or spin cycles, agitation or spinning time, the number of rinsings, etc. through a front panel on top of the washing machine, or through the data input means of the user's terminal. When the subscriber chooses an automatic washing operation, the controller of the washing machine automatically selects a washing course program, washing time, the number of washing repetitions, the number of agitation or spin cycles, agitation or spinning time, the number of rinsings, etc., which are appropriate to the amount of clothes in the tub. Such machine settings are selected after the washing machine has determined the amount of clothes in the machine tub.

After the washing machine settings are manually or automatically selected, if the subscriber presses a “start” button on the front panel of the washing machine, the washing cycle starts. Alternatively, a specific button, which is pre-defined for “washing start,” of the user's terminal (S20) may start the washing cycle. After the washing cycle has been initiated, the washing machine starts to wash the clothes in the tub. While the clothes are being washed, the controller transmits information related to the selected washing conditions, for example, the amount of clothes in tub, a washing course program, washing time, etc. to the user's terminal through the interfacing means 50. The user's terminal then delivers the received washing condition information to the washing management server 30 through the Internet 20 (S22).

After the washing management server receives the washing condition information, the washing management server 30 calculates the charge for the present washing service. Such charge calculations are based on the received washing condition information including the amount of clothes, the washing course program, washing time, etc. In addition, the washing management server receives the registered information for the subscriber, as well as possibly the unique number of the rental washing machine, its type, its load capacity, its motor type, etc.

When the clothes washing cycle is complete (“Yes” at the step S24), the controller of the washing machine 40 transmits a “washing-done” signal to the washing management server 30 through the user's terminal and the Internet 20. Then, the washing management server 30 adds the calculated charge to the total fee imposed from use of the rental washing for the current billing period, and it transmits both the calculated charge and the updated total fee to the user's terminal through the Internet 20 (S26).

After the terminal receives the charge information, the current charge and the total fee are displayed on the displaying means of the user's terminal. Alternatively, or in addition, this charge information may be delivered to the washing machine 40 and then displayed on the front panel thereof. Additionally, the washing management server 30 may print out a bill of the total fee including washing usage details and send it to the user's credit or debit card company or to the subscriber directly (S28).

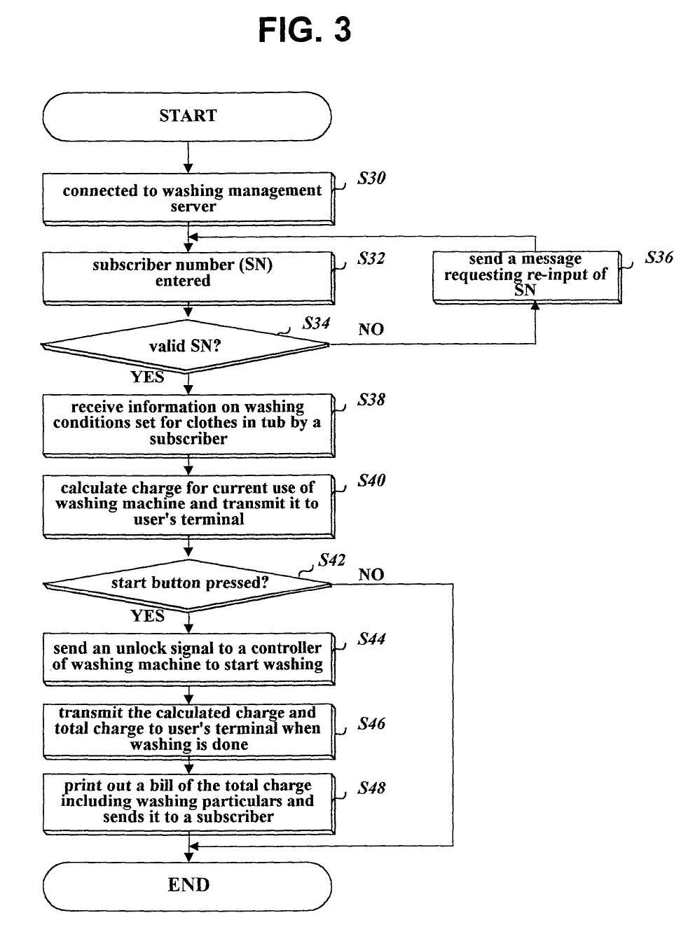

FIG. 3 is a flowchart of another embodiment of a method of managing use of rental electric home appliances through a communication network. The flowchart of FIG. 3 illustrates the procedures for which washing charges are estimated for current clothes and communicated to a subscriber or other consumer before washing is initiated. Furthermore, a completed washing service is charged based on a washing machine rental agreement incorporating the washing management server 30. Whether a washing machine has been installed in a laundry or other private or public facility does not affect the procedures of FIG. 3.

To begin use of the washing machine, a subscriber enters his or her subscriber number, preferably through one of the terminals 10a to 10n after being connected to a web site being run by the washing management server 30 through the Internet 20 (S30, S32). The entered subscriber number is then transmitted to the washing management server 30 through the Internet 20. The washing management server 30 receives and authenticates the subscriber number based on the registered subscriber information (S34).

If the received subscriber number is invalid (“No” at the step S34), the washing management server 30 sends a message requesting re-input of a subscriber number to the user's terminal through the Internet 20 (S36). If the received subscriber number is valid (“Yes” at the step S34), the washing management server 30 can then receive information on washing conditions setting through the Internet 20 (S38), or other communications network.

If the received subscriber number is valid, the subscriber is able to select various washing condition setting for clothes in the washing tub. Such settings may be entered through a front panel of the washing machine or the data input means of the user's terminal. After chosen washing condition settings are entered, the data is transferred to the washing management server 30 through the Internet 20. If the subscriber chooses an automatic washing operation, the controller of the washing machine determines the washing condition settings including a washing course program, washing time, the number of washing repetitions, the number of agitation or spin cycles, agitation or spin cycle time, the number of rinsings, etc., appropriate for the amount of clothes in the tub after measuring the amount of clothes. The automatically-determined washing condition settings are also transferred to the washing management server 30 through the Internet 20 and the user's terminal connected via the interfacing means 50.

After the washing management server 30 receives the washing condition settings, the washing management server 30 estimates the charge for the washing service. The estimated charge is based at least in part on the received washing condition settings including the amount of clothes, the washing course program to be executed, washing time, etc. The estimated charge is also based on the registered information for the subscriber, which may include the unique number of the rental washing machine, and washing machine type, load capacity, and motor type, etc. The washing management server 30 then sends the estimated charge to the user's or subscriber's terminal through the Internet 20 (S40).

If the estimated charge for selected washing service is displayed on the displaying means of the user's terminal, the subscriber can then determine whether to start the selected washing cycle based on whether the estimated charge is acceptable. If the subscriber wants to proceed with washing, he or she presses a “start” button. If the subscriber chooses to not proceed with the washing cycle because the charge is too high, he or she may press a “cancel” button to terminate the wash cycle before incurring any charges.

When the subscriber presses the “start” button on the front panel of the washing machine or a pre-defined specific button of the user's terminal (“Yes” at the step S42), the controller sends a “start-requested” signal to the washing management server 30 through the Internet 20. After receiving the “start-requested” signal, the washing management server 30 sends an “unlock” signal to the controller of the washing machine through the Internet 20 as well as to the user's terminal in order to unlock the washing machine and initiate the washing process (S44).

When the selected washing cycle is complete, the controller of the washing machine transmits a “washing-done” signal to the washing management server 30 through the user's terminal over the Internet 20. The washing management server 30 adds the estimated charge, which is the charge for the current washing cycle, to the total fee imposed from use of the rental washing machine for the current filling period. Current and total charges are then sent to the user's terminal through the Internet 20 (S46). Then, the current charge and the total charge for the filing period are displayed on the display of the user's terminal. In addition, or alternatively, this charge information may be delivered to the washing machine and then displayed on the front panel thereof. The washing management server 30 may also print out a bill of the total fee including washing usage details and sends it to the subscriber's credit card company or to the subscriber directly (S48).

In another preferred embodiment, the subscriber may place a telephone call to an operator of the washing management server and provide the unique number of the rental washing machine and his or her subscriber number. An appliance rental company which controls the washing machine is notified of the request for washing service by the operator. The appliance rental company may then remotely activate the washing machine identified by the unique number. The unique number and the subscriber number can be delivered to the operator or the washing management server in a digital data format through a notebook computer, a personal computer, or a telephone.

In another preferred embodiment, a pre-paid cash card, may be sold for the use of washing machines installed in public or private laundry facilities. When a washing machine reads an inserted pre-paid cash card with or without contacting the washing management service, the washing machine executes the selected washing cycle if the remaining balance on the card is larger than the charge for the selected washing service. If a pre-paid cash card contains an appropriate subscriber number, a subscriber carrying the card can use a washing machine managed by the washing management server at any location. Alternatively, a debit card or a credit card can be validated to start use of the appliance, and the usage charges can be billed against the debit card or credit card.

The method of managing the use of rental electric home appliances through a communication network according to the present invention makes it unnecessary for the user to buy electric home appliances such as a washing machine, etc. By using an embodiment of the invention, a subscriber need not suffer the expense and inconvenience of appliance installation, repair, replacement, or transferring the appliance when the user moves to a new location. Additionally, the subscriber can use brand-new electric home appliances whenever the subscriber desires as provided by the rental service provider. Furthermore, the rental service provider can satisfy various consumer's or subscriber's needs promptly, which will result in increased profits.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of managing use of an appliance, comprising:
receiving information on a use of the appliance through a communication network;
calculating a charge for the use of the appliance based on the received use information; and
transmitting the calculated charge to a user's terminal through the communication network.

2. The method of claim 1, wherein said appliance is a washing machine.

3. The method of claim 2, wherein said received use information for calculating a charge includes at least one of a type of washing machine, a load capacity of the washing machine, a motor type of the washing machine, an amount of clothes to be washed, a selected washing course program, a selected washing time, a selected number of washing repetitions, a selected number of agitation or spin cycles, and a number of rinsing repetitions.

4. The method of claim 1, wherein the appliance is activated by a start signal from a registered subscriber's personal computer or a mobile terminal.

5. The method of claim 1, further comprising:
entering a subscriber number and a unique number of an appliance through a communication network;
authenticating said subscriber number and said unique number of an appliance; and
activating said appliance if said subscriber number and said unique number of an appliance are authentic.

6. The method of claim 1, wherein the user's terminal is a personal computer or a mobile terminal.

7. The method of claim 1, further comprising sending a for use of the appliance after each use of the appliance to a corresponding subscriber.

8. A method of managing the use of an appliance through a communication network, comprising:
authenticating a subscriber number received through the communication network;
transmitting a start signal for an appliance identified by the subscriber number from a server through the communication network to a corresponding subscriber's terminal if the subscriber number is authenticated successfully;
receiving use information of the appliance through the communication network;
calculating a charge for the use of the appliance based on the received use information; and
transmitting the calculated charge to the subscriber's terminal through the communication network.

9. The method of claim 8, wherein said appliance is a washing machine.

10. The method of claim 9, wherein the use information includes at least one of a selected type of the washing machine, a load capacity of the washing machine, a motor type of the washing machine, an amount of clothes to be washed, a selected washing course program, a selected washing time, a selected number of washing repetitions, a selected number of agitation or spin cycles, and a number of rinsing repetitions.

11. The method of claim 8, further comprising starting the appliance when the start signal is received by the subscriber's terminal.

12. The method of claim 8, further comprising:
entering a subscriber number and a unique number of an appliance through a communication network;
authenticating said subscriber number and said unique number of an appliance; and
activating said appliance if said subscriber number and said unique number of an appliance are authentic.

13. The method of claim 8, wherein the subscriber's terminal is a personal computer or a mobile terminal.

14. The method of claim 8, further comprising sending a bill for use of the appliance after each use of the appliance to a corresponding subscriber.

15. A method of managing use of a washing machine through a communication network, comprising:
receiving information on washing condition program settings based on clothes inserted in the washing machine through the communication network;
calculating a charge for use of the washing machine based on the received information;
transmitting the calculated charge to a user's terminal through the communication network; and
transmitting a start signal to the washing machine through the communication network if a washing request is received.

16. The method of claim 15, wherein said received information includes at least one of a type of the washing machine, a load capacity of the washing machine, a motor type of the washing machine, an amount of clothes to wash, a selected washing course program, a washing time, a number of washing repetitions, a selected number of agitation or spin cycles, and a selected number of rinsing repetitions.

17. The method of claim 15, wherein the user's terminal comprises a personal computer or a mobile terminal.

18. The method of claim 15, further comprising sending a bill for use of the washing machine after each use of the washing machine to a corresponding subscriber.

19. A method of managing use of an appliance through a communication network, comprising:
authenticating a subscriber number received through the communication network;
receiving automatically selected information on appliance use conditions through the communication network;
calculating a charge for use of the appliance, if the subscriber number is authenticated successfully;
transmitting the calculated charge to a subscriber's terminal through the communication network; and
transmitting a start signal to the appliance through the communication network if a start request is received.

20. The method of claim 19, wherein said appliance is a washing machine and wherein said received information includes at least one of a type of the washing machine, a load capacity of the washing machine, a motor type of the washing machine, an amount of clothes to be washed, a selected washing course program, a selected washing time, a selected number of washing repetitions, a selected number of spin cycles, and a selected number of rinsing repetitions.

21. The method of claim 19, wherein the subscriber's terminal comprises a personal computer or a mobile terminal.

22. The method of claim 19, further comprising sending a bill for use of the applicance after each use of the appliance to a corresponding subscriber.

23. A method of managing a usage of an appliance, comprising:
receiving a subscriber number from a user over a communication network;
validating said subscriber number;
configuring an appliance for use if said subscriber number is valid;
receiving usage information from said appliance over the communication network;
calculating charge information based on said usage information; and
transmitting said charge information to said user.

24. The method of claim 23, further comprising transmitting said charge information to said user after said user has used said appliance.

25. The method of claim 23, further comprising transmitting said charge information to said user before said subscriber has used said appliance.

26. The method of claim 25, further comprising cancelling use of said appliance after transmitting said charge information to said user and before said subscriber has used said appliance.

27. The method of claim 23, wherein configuring an appliance for use further comprises activating said appliance when said user pushes a start button.

28. The method of claim 23, wherein transmitting said charge information to said user further comprises displaying said charge information on a display means.

29. The method of claim 23, wherein validating said subscriber number comprises validating a debit, credit or pre-paid card, and wherein transmitting said charge information to said user further comprises billing said debit, credit or pre-paid card based on said charge information.
